(19) United States
(12) Patent Application Publication
(10) Pub. No.: US 2012/0217325 A1
(43) Pub. Date: Aug. 30, 2012

(54) Pressurized Liquid Dispensing Mobile Unit and System

(76) Inventor: James Broadbent, Woodlyn, PA (US)

(21) Appl. No.: 13/034,099

(22) Filed: Feb. 24, 2011

(51) Int. Cl. B05B 3/18; B05B 3/02; B05B 15/00; B08B 3/02

(52) U.S. Cl. 239/754; 239/264

(57) ABSTRACT

A pressurized liquid dispensing mobile unit used to treat metallic surfaces by applying liquid under pressure to such surfaces. The pressurized liquid dispensing mobile unit has two endless tracks that move the unit over the surface being treated. Each track has magnetic sections that hold the unit to the surface being treated. Liquid under pressure is supplied to liquid dispensing means that are mounted for movement between a first position at which liquid is dispensed under pressure and a second position at which liquid is not dispensed and an observer has an unobstructed view of the liquid dispensing means. The movement of the pressurized liquid dispensing mobile unit along the surface being treated and the supply of liquid under pressure to the unit for treatment of the surface on which the pressurized liquid dispensing mobile unit is mounted are controlled from a remote location.

### FIELD OF THE INVENTION

The present invention relates, in general, to the treatment of structural surfaces and, in particular, to the cleaning of large structural surfaces by the application of water under very high pressure.

### BACKGROUND

There are many large structural metallic structures, such as the hulls of ships, oil storage tanks, gas holders, and buildings, that require maintenance. Such maintenance can include cleaning paint, rust, and debris from the surface of the structure.

Among the ways these structures are cleaned is grit blasting. Grit blasting is expensive and exposes the operators of the equipment to health hazards.

Another common practice for cleaning large metallic structures is to apply water under high pressure to the surface being cleaned. There are many remotely controlled pressurized water dispensing mobile units in use today for cleaning large metallic surfaces. Generally, these units suffer from one or more shortcomings. Some are very expensive. Others function at much too slow rates. Some are difficult or expensive to maintain. Others suffer from the shortcoming that the pressure of the water being dispensed is limited by the “holding” capability of the mobile unit to the surface of the metallic structure being cleaned. As the water pressure is increased, the back pressure tends to separate the mobile unit from the surface being cleaned. Higher pressures are desired because higher pressures increase the effectiveness of the mobile cleaning unit in greater efficiency and reduced costs.

### SUMMARY

A pressurized liquid dispensing mobile unit, constructed in accordance with the present invention, includes a frame having first and second parallel longitudinal sides, first and second gear wheels mounted to the frame at the first longitudinal side of the frame for rotary movement relative to the frame, and a first endless track having a plurality of magnetic sections extending between and around the first gear wheel and the second gear wheel for movement parallel to the first longitudinal side of the frame as the first gear wheel and the second gear wheel undergo rotary movement. A pressurized liquid dispensing mobile unit, constructed in accordance with the present invention, also includes third and fourth gear wheels mounted to the frame at the second longitudinal side of the frame for rotary movement relative to the frame and a second endless track having a plurality of magnetic sections extending between and around the third gear wheel and the fourth gear wheel for movement parallel to the second longitudinal side of the frame as the third gear wheel and the fourth gear wheel undergo rotary movement. A pressurized liquid dispensing mobile unit, constructed in accordance with the present invention, further includes a first power source mounted to the frame and a second power source mounted to the frame. The first power source is coupled to the first endless track by first coupling means to impart movement to the first endless track and the second power source is coupled to the second endless track by second coupling means to impart movement to impart movement to the second endless track. A pressurized liquid dispensing mobile unit, constructed in accordance with the present invention, further includes liquid supply means for supplying liquid under pressure and liquid dispensing means mounted for movement between and a first closed position at which liquid is dispensed and a second open position at which liquid is not dispensed and an observer has an unobstructed view of the liquid dispensing means. A pressurized liquid dispensing mobile unit, constructed in accordance with the present invention, also includes control means for selectively activating the first power source to impart movement to the first endless track, selectively activating the second power source to impart movement to the second endless track; and selectively supplying liquid under pressure from the liquid supply means to the liquid dispensing means.

### BRIEF DESCRIPTION OF THE DRAWINGS

FIG. 1 is a front view, partially in section, of a pressurized liquid dispensing mobile unit constructed in accordance with the present invention.

FIG. 2 is a top view of the FIG. 1 pressurized liquid dispensing mobile unit.

FIG. 3 is a rear view of the FIG. 1 pressurized liquid dispensing mobile unit.

FIG. 4 is a bottom view of the FIG. 1 pressurized liquid dispensing mobile unit.

FIG. 5 is a side view of the FIG. 1 pressurized liquid dispensing mobile unit, taken from the right side of FIG. 1, with the liquid dispensing means disposed in the closed position at which liquid is dispensed.

FIG. 6 is a side view, similar to FIG. 5, of the FIG. 1 pressurized liquid dispensing mobile unit with the liquid dispensing means disposed in the open position at which liquid is not dispensed.

FIG. 7 is a bottom view, similar to FIG. 4, of the FIG. 1 pressurized liquid dispensing mobile unit with different liquid dispensing means from the FIG. 1 liquid dispensing means.

### DETAILED DESCRIPTION OF THE EMBODIMENTS

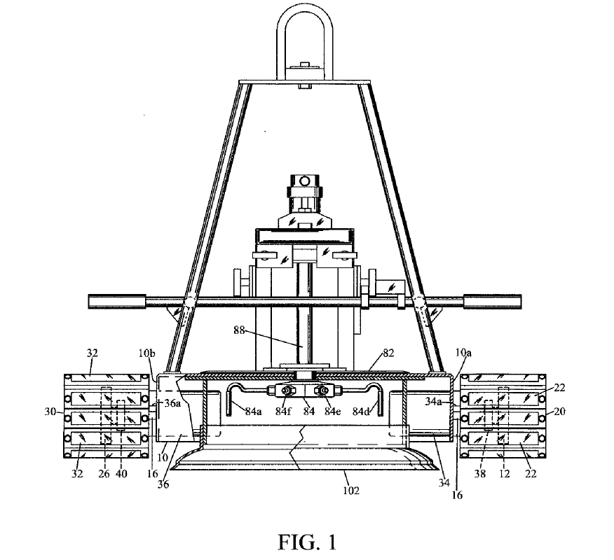

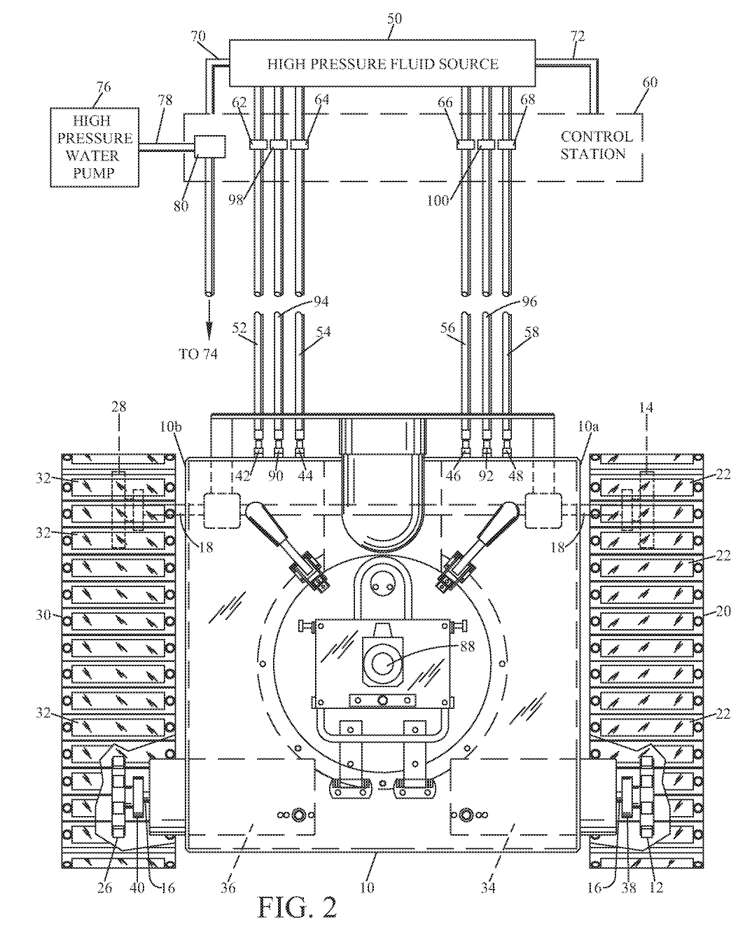

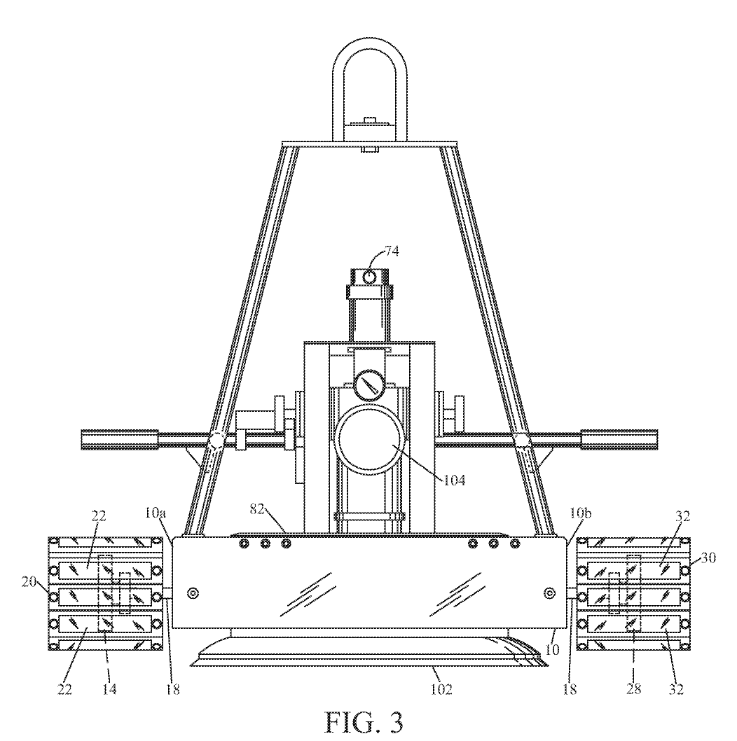

Referring to FIGS. 1 through 6, a pressurized liquid dispensing mobile unit, constructed in accordance with the present invention, includes a frame 10 having first and second parallel longitudinal sides 10a and 10b, respectively. Frame 10 can be fabricated from a suitable metal and provides support for various components of the pressurized liquid dispensing mobile unit to be described.

A pressurized liquid dispensing mobile unit, constructed in accordance with the present invention, also includes first and second gear wheels 12 and 14, respectively, mounted to frame 10 at first longitudinal side 10a of the frame for rotary movement relative to the frame. First gear wheel 12 is mounted for rotation to frame 10 by a first axle 16 and second gear wheel 14 is mounted for rotation to frame 10 by a second axle 18.

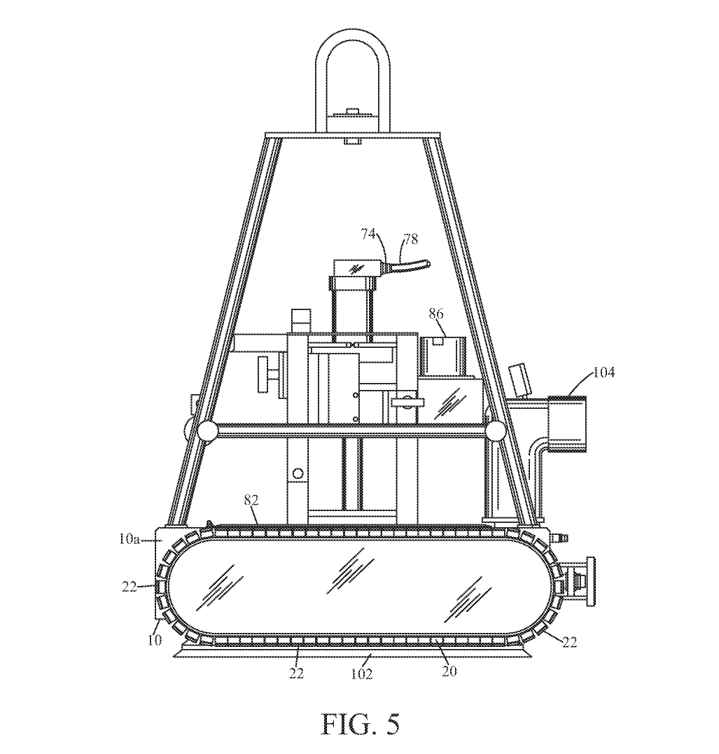

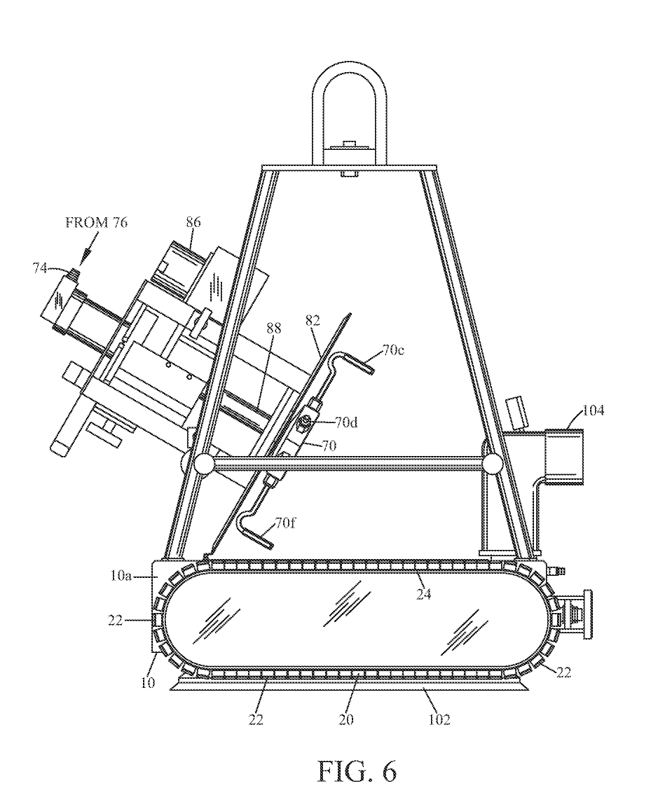

A pressurized liquid dispensing mobile unit, constructed in accordance with the present invention, also includes a first endless track 20 having a plurality of magnetic sections 22 extending between and around first gear wheel 12 and second gear 16 wheel for movement parallel to first longitudinal side 10a of frame 10 as the first gear wheel and the second gear wheel undergo rotary movement. First endless track 20 includes a first endless sprocket chain 24, shown most clearly in FIGS. 5 and 6, that engages first gear wheel 12 and second gear wheel 14 and extends between and around the first and second gear wheels. Magnetic sections 22 of first endless track 20 are treads extending transverse to the direction of movement of the first endless track and are secured by suitable means to move with first endless sprocket chain 24. Magnetic sections 22 can be formed of a rare earth material such as the special neodymium magnetic assembly sold by Magnetic Hold, Inc.

A pressurized liquid dispensing mobile unit, constructed in accordance with the present invention, also includes third and fourth gear wheels 26 and 28, respectively, mounted to frame 10 at second longitudinal side 10b of the frame for rotary movement relative to the frame. Third gear wheel 26 is mounted for rotation to frame 10 by first axle 16 and fourth gear 28 is mounted for rotation to frame 10 by second axle 18.

A pressurized liquid dispensing mobile unit, constructed in accordance with the present invention, also includes a second endless track 30 having a plurality of magnetic sections 32 extending between and around third gear wheel 26 and fourth gear wheel 28 for movement parallel to second longitudinal side 10b of frame 10 as the third gear wheel and the fourth gear wheel undergo rotary movement. Second endless track 30 includes a second endless sprocket chain (not shown in the drawings) that is similar to first endless sprocket chain 24 of first endless track 20, shown most clearly in FIGS. 5 and 6, that engages third gear wheel 26 and fourth gear wheel 28 and extends between and around the third and fourth gear wheels. Magnetic sections 32 of second endless track 30 are treads extending transverse to the direction of movement of the second endless track and are secured to move with the second endless sprocket chain in a way similar to the way magnetic sections 22 are secured to move with first endless sprocket chain 24. Magnetic sections 32 can be formed of a rare earth material such as the special neodymium magnetic assembly sold by Magnetic Hold, Inc.

A pressurized liquid dispensing mobile unit, constructed in accordance with the present invention, also includes a first power source 34 mounted to frame 10 and a second power source 36 mounted to frame 10. First power source 34 and second power 36 preferably are hydraulic motors of conventional construction and operation.

In accordance with the present invention, first power source 34 is coupled to first endless track 20 by first coupling means to impart movement to first endless track 20. For the particular embodiment of the present invention that is illustrated and being described, the first coupling means can be a gear train of conventional construction and operation that couples output shaft 34a of hydraulic motor 34 to first endless sprocket chain 24 of first endless track 20 by a sprocket 38.

In a similar manner, second power source 36 is coupled to second endless track 30 by second coupling means to impart movement to second endless track 30. As with the first coupling means, the second coupling means can be a gear train of conventional construction and operation that couples output shaft 36a of hydraulic motor 36 to the second endless sprocket chain of second endless track 30 by a sprocket 40.

Hydraulic motors 34 and 36, a plurality of fittings 42, 44, 46, and 48, and a remotely located high pressure fluid source 50 are parts of a closed loop hydraulic system. The remotely located high pressure fluid source 50 can be a pump of conventional construction and operation that delivers high pressure fluid (e.g., oil, air) to fittings 42 and 46 via hoses 52 and 56, respectively, and receives return high pressure fluid from fittings 44 and 48 via hoses 54 and 58, respectively. Fittings 42, 44, 48, and 48 are hydraulically connected to hydraulic motors 34 and 36 by suitable means that are not shown in complete detail in the drawings but are well within the knowledge of those skilled in the art.

A remotely located control station 60 controls activation and deactivation of hydraulic motors 34 and 36. A plurality of valves 62, 64, 66, and 68, positioned in hoses 52, 54, 56, and 58, respectively, and located at the control station are controlled at the controlled station. High pressure fluid source 50 has two manually operated valves (not shown). One of these valves is opened to permit the supply of high pressure fluid from the high pressure fluid source to control station 60 via a hose 70 and the other of these valves is opened to permit the return of high pressure fluid to the high pressure fluid source via a hose 72. The operation of valves 62, 64, 66, and 68 is controlled at control station 60 by suitable means well-know to those skilled in the art.

The pressurized liquid dispensing mobile unit operates in the following manner:

When the pressurized liquid dispensing mobile unit is to move forward in a straight line, (1) equal levels of high pressure fluid from high pressure fluid source 50 are conducted from fittings 42 and 44 to hydraulic motors 34 and 36, respectively, to cause the hydraulic motors to turn in a first direction, and (2) equal levels of high pressure fluid returned from hydraulic motors 34 and 36 are returned to high pressure fluid source 50 via fittings 46 and 48, respectively.

When the pressurized liquid dispensing mobile unit is to move backward in a straight line, (1) equal levels of high pressure fluid from high pressure fluid source 50 are conducted from fittings 46 and 48 to hydraulic motors 34 and 36, respectively, to cause the hydraulic motors to turn in a second direction opposite from the first direction, and (2) equal levels of high pressure fluid returned from hydraulic motors 34 and 36 are returned to high pressure fluid source 50 via fittings 42 and 44, respectively.

When the pressurized liquid dispensing mobile unit is to move forward along a curved line, the operation is the same as with moving forward in a straight line, except the levels of high pressure fluid conducted to hydraulic motors 34 and 36 from valve fittings 42, 44, 46, and 48 and returned to high pressure fluid source 50 from fittings 42, 44, 46, and 48 are different and dependent upon the direction the pressurized liquid dispensing mobile unit is to take.

When the pressurized liquid dispensing mobile unit is to move backward along a curved line, the operation is the same as with moving backward in a straight line, except the levels of high pressure fluid conducted to hydraulic motors 34 and 36 from fittings 42, 44, 46, and 48 and returned to high pressure fluid source 50 from fittings 42, 44, 46, and 48 are different and dependent upon the direction the pressurized liquid dispensing mobile is to take.

A pressurized liquid dispensing mobile unit, constructed in accordance with the present invention, also includes liquid supply means for supplying liquid under pressure. For the embodiment of the present invention that is illustrated and being described, liquid under pressure enters the pressurized liquid dispensing mobile unit via a fitting 74 that is connected to a remotely located high pressure water pump 76 by a hose 78. A valve 80, positioned in hose 78 and located at control station 60, controls the delivery of liquid from high pressure water pump 76 to the pressurized liquid dispensing mobile unit. The operation of valve 80 is controlled at control station 60 by suitable means well-know to those skilled in the art.

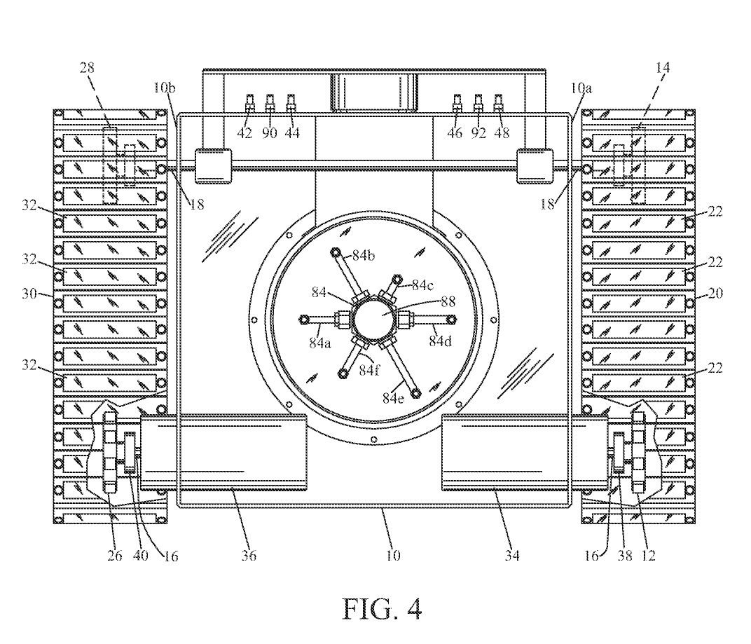

A pressurized liquid dispensing mobile unit, constructed in accordance with the present invention, also includes liquid dispensing means mounted for movement between a first closed position at which liquid is dispensed and a second open position at which liquid is not dispensed and an observer has an unobstructed view of and access to the liquid dispensing means. For the embodiment of the present invention that is illustrated and being described, the liquid dispensing means include a lid 82 hinged to frame 10 and an array 84 of individual nozzles 84a-84f mounted to lid 82 with each nozzle extending radially outward from a common point a selected distance, as shown most clearly in FIG. 4. The array 84 of spray nozzles, known to those skilled in the art as a spider array, can be a large diameter surface cleaning manifold, such as the A.M. Gatti, Inc., Type 3300. Spray nozzle array 84 is mounted to lid 82 for rotational movement relative to the lid.

A pressurized liquid dispensing mobile unit, constructed in accordance with the present invention, further includes a third power source 86 mounted for movement with lid 82 and third coupling means for coupling third power source 86 to the spider spray 84 to impart rotary movement to the spider array. Third power source 86 preferably is a hydraulic motor of conventional construction and operation. For the particular embodiment of the present invention that is illustrated and being described, the third coupling means can be a pulley/belt unit (not shown) of conventional construction and operation that couples a pulley, mounted to the output shaft (not shown) of hydraulic motor 86, to a pulley, mounted to the drive shaft 88 of spider array 84, via a belt.

Hydraulic motor 86, a pair of fittings 90 and 92, and high pressure fluid source 50 are parts of a closed loop hydraulic system. High pressure fluid source 50 delivers high pressure fluid to fitting 90 via a hose 94 and receives return high pressure fluid from fitting 92 via a hose 96. Fittings 90 and 92 are hydraulically connected to hydraulic motor 86 by suitable means that are not shown in complete detail in the drawings but are well within the knowledge of those skilled in the art.

Control station 60 controls activation and deactivation of hydraulic motor 86. A pair of valves 98 and 100, positioned in hoses 94 and 96, respectively, and located at the control station are controlled at the control station. The operation of valves 98 and 100 is controlled at control 60 by suitable means well-known to those skilled in the art.

Valves 98 and 100 selectively control activation and deactivation of hydraulic motor 86, as well as the pressure level of the high pressure fluid delivered to hydraulic motor 86 and the pressure level of the high pressure fluid returned from hydraulic motor 86, by controlling the passage of high pressure fluid from high pressure fluid source 50 to hydraulic motor 86 and the passage of high pressure fluid from hydraulic motor 86 to the high pressure fluid source. As high pressure fluid is delivered to hydraulic motor 86, the hydraulic motor imparts rotary movement to spider array 84 and the surface on which the pressurized liquid dispensing mobile unit is mounted is cleaned by high pressure water emitted from the nozzles of the rotating spider array.

As high pressure water, introduced via fitting 74, is sprayed against a surface being cleaned, a vacuum is developed in the space between the pressurized liquid dispensing mobile unit and the surface being cleaned due to a seal between a flexible skirt 102, mounted to frame 10, and the surface being cleaned. The spray water and particulate matter removed from the surface being cleaned leave the pressurized liquid dispensing mobile through a vacuum port 104 and are deposited in a suitable container (not shown) for disposal.

Among in the benefits derived from a pressurized liquid dispensing mobile unit constructed in accordance with the present invention is the facility of inspecting and maintaining the liquid dispensing means while the pressurized liquid dispensing mobile unit remains in place on a surface being cleaned. Instead of removing the pressurized liquid dispensing mobile unit from the surface being cleaned and moving it to another location to either inspect or maintain the liquid dispensing means, the operator of the equipment simply lifts lid 82 while the equipment is still held on the surface being cleaned and has an unobstructed view of the liquid dispensing means and unobstructed access to the liquid dispensing means should maintenance be necessary.

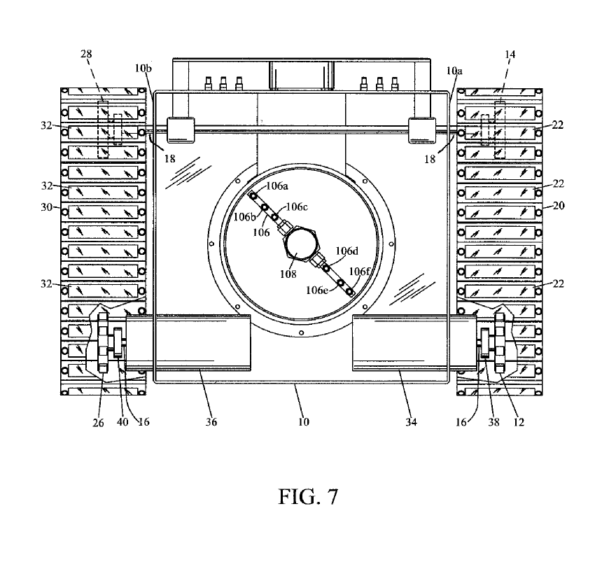

The FIG. 7 embodiment of the present invention differs from the FIGS. 1-6 embodiment only by the substitution of a spray bar 106 as the nozzle array for the spider array 84 as the water spray component. Spray bar 106 can be the A.M. Gatti, Inc., 10″ Jet Spray Bar P/N 3743. As shown in FIG. 7, spray bar 106 has a plurality of nozzles 106a-106f disposed along the length of the spray bar. Spray bar 106 is mounted for rotary movement relative to lid 82 and rotary movement is imparted to the spray bar by a hydraulic motor, the output shaft of which is coupled to a drive shaft 108 of the spray bar.

The foregoing illustrates some of the possibilities for practicing the invention. Many other embodiments are possible within the scope and spirit of the invention. It is, therefore, intended that the foregoing description be regarded as illustrative rather than limiting, and that the scope of the invention is given by the appended claims together with their full range of equivalents.

What is claimed is:

1. A pressurized liquid dispensing mobile unit comprising:
a frame having first and second parallel longitudinal sides;
first and second gear wheels mounted to said frame at said first longitudinal side of said frame for rotary movement relative to said frame;
a first endless track having a plurality of magnetic sections extending between and around said first gear wheel and said second gear wheel for movement parallel to said first longitudinal side of said frame as said first gear wheel and said second gear wheel undergo rotary movement;
third and fourth gear wheels mounted to said frame at said second longitudinal side of said frame for rotary movement relative to said frame;
a second endless track having a plurality of magnetic sections extending between and around said third gear wheel and said fourth gear wheel for movement parallel to said second longitudinal side of said frame as said third gear wheel and said fourth gear wheel undergo rotary movement;
a first power source mounted to said frame;
a second power source mounted to said frame;
first coupling means for coupling said first power source to said first endless track to impart movement to said first endless track;
second coupling means for coupling said second power source to said second endless track to impart movement to said second endless track;
liquid supply means for supplying liquid under pressure;
liquid dispensing means mounted for movement between:
(a) a first closed position at which liquid is dispensed, and
(b) a second open position at which liquid is not dispensed and an observer has an unobstructed view of said liquid dispensing means;
control means for selectively:
(a) activating said first power source to impart movement to said first endless track,
(b) activating said second power source to impart movement to said second endless track; and
(c) supplying liquid under pressure from said liquid supply means to said liquid dispensing means.

2. A pressurized liquid dispensing mobile unit according to claim 1 wherein said liquid dispensing means include:
(a) a lid hinged to said frame for pivotal movement between the first closed position and the second open position, and
(b) an array of nozzles mounted to said lid.

3. A pressurized liquid dispensing mobile unit according to claim 2 wherein said array of nozzles is a spray bar mounted for rotary movement relative to said lid and having a plurality of nozzles disposed along the length of said spray bar.

4. A pressurized liquid dispensing mobile unit according to claim 3 further including:
(a) a third power source, and
(b) third coupling means for coupling said third power source to said spray bar to impart rotary movement to said spray bar.

5. A pressurized liquid dispensing mobile unit according to claim 4 wherein said first power source, said second power source, and said third power source are hydraulic motors.

6. A pressurized liquid dispensing mobile unit according to claim 2 wherein said array of nozzles is a plurality of individual nozzles each extending radially outward from a common point a selected distance.

7. A pressurized liquid dispensing mobile unit according to claim 6 wherein said individual nozzles are mounted for rotary movement relative to said lid.

8. A pressurized liquid dispensing mobile unit according to claim 6 further including:
(a) a third power source, and
(b) third coupling means for coupling said third power source to said individual nozzles to impart rotary movement to said individual nozzles.

9. A pressurized liquid dispensing mobile unit according to claim 8 wherein said first power source, said second power source, and said third power source are hydraulic motors.

10. A pressurized liquid dispensing system comprising:
a pressurized liquid dispensing mobile unit having:
(a) a frame having first and second parallel longitudinal sides,
(b) first and second gear wheels mounted to said frame at said first longitudinal side of said frame for rotary movement relative to said frame,
(c) a first endless track having a plurality of magnetic sections extending between and around said first gear wheel and said second gear wheel for movement parallel to said first longitudinal side of said frame as said first gear wheel and said second gear wheel undergo rotary movement,
(d) third and fourth gear wheels mounted to said frame at said second longitudinal side of said frame for rotary movement relative to said frame,
(e) a second endless track having a plurality of magnetic sections extending between and around said third gear wheel and said fourth gear wheel for movement parallel to said second longitudinal side of said frame as said third gear wheel and said fourth gear wheel undergo rotary movement,
(f) a first power source mounted to said frame,
(g) a second power source mounted to said frame,
(h) first coupling means for coupling said first power source to said first endless track to impart movement to said first endless track,
(i) second coupling means for coupling said second power source to said second endless track to impart movement to said second endless track,
(j) liquid supply means for supplying liquid under pressure,
(k) liquid dispensing means mounted for movement between:
(1) a first closed position at which liquid is dispensed, and
(2) a second open position at which liquid is not dispensed and an observer has an unobstructed view of said liquid dispensing means;
a remotely located power source;
means for connecting said remotely located power source to said pressurized liquid dispensing mobile unit;
a remotely located liquid supply;
means for connecting said remotely located liquid supply to said pressurized liquid dispensing mobile unit; and
remotely located control means for selectively:
(a) activating said remotely located power source to supply power to said pressurized liquid dispensing mobile unit,
(b) activating said remotely located liquid supply to supply liquid to said pressurized liquid dispensing unit,
(c) activating said first power source to impart movement to said first endless track,
(d) activating said second power source to impart movement to said second endless track; and
(e) activating said liquid supply means to supply liquid to said liquid dispensing means.

11. A pressurized liquid dispensing system according to claim 10 wherein said liquid dispensing means include:
(a) a lid hinged to said frame for pivotal movement between the first closed position and the second open position, and
(b) an array of nozzles mounted to said lid.

12. A pressurized liquid dispensing mobile unit according to claim 11 wherein said array of nozzles is a spray bar mounted for rotary movement relative to said lid and having a plurality of nozzles disposed along the length of said spray bar.

13. A pressurized liquid dispensing mobile unit according to claim 12 further including:
(a) a third power source, and
(b) third coupling means for coupling said third power source to said spray bar to impart rotary movement to said spray bar.

14. A pressurized liquid dispensing mobile unit according to claim 13 wherein said first power source, said second power source, and said third power source are hydraulic motors.

15. A pressurized liquid dispensing mobile unit according to claim 11 wherein said array of nozzles is a plurality of individual nozzles each extending radially outward from a common point a selected distance.

16. A pressurized liquid dispensing mobile unit according to claim 15 wherein said individual nozzles are mounted for rotary movement relative to said lid.

17. A pressurized liquid dispensing mobile unit according to claim 16 further including:
(a) a third power source, and
(b) third coupling means for coupling said third power source to said individual nozzles to impart rotary movement to said individual nozzles.

18. A pressurized liquid dispensing mobile unit according to claim 17 wherein said first power source, said second power source, and said third power source are hydraulic motors.
